(19) United States
(12) Patent Application Publication
(10) Pub. No.: US 2010/0307101 A1
(43) Pub. Date: Dec. 9, 2010

(54) INSECTICIDE-EQUIPPED PARTICLES MADE OF EXPANDABLE POLYSTYRENE AND INSECTICIDE-EQUIPPED MOLDED PARTS WHICH CAN BE OBTAINED THEREFROM

(75) Inventors: Michael Ishaque, Mannheim (DE); Olaf Kriha, Ludwigshafen (DE); Carsten Schips, Speyer (DE); Norbert Güntherberg, Speyer (DE); Daniela Longo, Siegburg (DE); Klaus Hahn, Kirchheim (DE); Bernhard Schmied, Frankenthal (DE); Clark D. Klein, Pittsboro, NC (US); Keith A. Holmes, Cary, NC (US)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/808,422

(22) PCT Filed: Dec. 19, 2008
(86) PCT No.: PCT/EP08/67962

§ 371 Date: Jun. 16, 2010

Related U.S. Application Data
(60) Provisional application No. 61/016,005, filed on Dec. 21, 2007.

(51) Int. Cl. E04B 1/72; B29C 63/22; B29C 44/16; A01N 25/08; A01N 43/56; A01N 37/34; A01N 43/40; A01N 59/14; A01P 7/04

(52) U.S. Cl. 52/741.3; 264/241; 264/45.4; 424/409; 514/407; 514/520; 514/341; 424/660

(57) ABSTRACT

Insecticide-modified bead material composed of expandable polystyrene (EPS) coated with
(A) one or more insecticides
(B) one or more glycerol esters
(C) if desired, one or more binders, and
(D) if desired, further additives.

The invention relates to insecticide-modified bead material composed of expandable polystyrene, to insecticidal moldings obtainable therefrom, to processes for their production, and also to their use in the construction industry.

Polymer foams are used by way of example in the construction industry as insulation material both above and below ground. Consumption by insects, in particular termites, can substantially damage these foams, thus compromising the insulating action, and also the mechanical stability of the moldings, and so permitting further pest encroachment. In many cases state regulations require an insecticidal protection of polymer foams because such isolation materials offer a preferred habitat for termites.

JP-2000-001564 describes the use of (±)-5-amino-1-(2,6-dichloro-α,α,α,-trifluoro-p-tolyl)-4-trifluoromethylsulfinylpyrazole (common name: fipronil) for the protection of polymer foams. Concentrations of fipronil used for this purpose are from 0.001 to 1% by weight. Polystyrene, polyethylene, and polypropylene are described as polymer matrix. The fipronil is incorporated by application to the surface of the finished molding, by application to the surface of the prefoamed foam beads, or by application to the pellets comprising blowing agent.

JP 2001-259271 describes a process in which EPS pellets comprising blowing agent, or prefoamed EPS pellets, are coated with fipronil and with a binder. The processes mentioned can create undesired abraded material and dusting during production. Since this abraded material or dust comprises large amounts of active ingredient, undesired exposure is likely, as also is loss of active ingredient during production, processing, and/or use.

An object was therefore to improve the processes described in JP-2000-001564 and JP 2001-259271 with respect to undesired exposure and loss of active ingredient during processing. In particular, an object was to provide insecticide-modified bead material composed of expandable polystyrene (EPS bead material) which leads, during production, processing, and use, to relatively low exposure to active ingredient, and with this to relatively low loss of active ingredient.

The object is achieved through a coating for the bead material, where the coating comprises not only one or more insecticides but at least one glycerol ester and optionally one or more binders.

The invention therefore provides a bead material composed of expandable polystyrene (EPS), coated with
(A) one or more insecticides
(B) one or more glycerol esters
(C) if desired, one or more binders, and
(D) if desired, further additives.

The invention further provides insecticides, foamed moldings obtainable from the inventive bead material, processes for production of the bead material and moldings, and also their use in the construction industry as a construction material, in particular as insulation material.

The inventive coating of EPS bead material leads to an improvement in the abrasion resistance of the insecticidal coating of the EPS bead material and of the molding obtainable therefrom. It has moreover been found that the inventive EPS bead material and the moldings obtainable therefrom have improved insecticidal activity when compared with EPS bead material and moldings obtainable therefrom which have been treated according to the prior art. This permits a reduction in the amount of insecticide, thus giving a more economic and more environmentally compatible coating process.

The inventive moldings moreover have no disadvantages in mechanical and insulation properties when compared with a standard product (without insecticide).

For the purposes of the invention, EPS is a collective term for homo- and copolymers composed of styrene, of other vinylaromatic monomers, and, if desired, of further comonomers. EPS includes by way of example standard polystyrene (general-purpose polystyrene, GPPS, usually glass-clear), impact-modified polystyrene (high-impact polystyrene, HIPS, comprising, for example, polybutadiene rubber or polyisoprene rubber), styrene-maleic acid/anhydride polymers, acrylonitrile-butadiene-styrene polymers (ABS), styrene-acrylonitrile polymers (SAN), or a mixture of these (component K1). Preferred EPS is standard polystyrene, which is substantially based on styrene (preferably to an extent of at least 95 mol %, based on monomer content).

EPS also comprises blends composed of one or more of the abovementioned polymers (component K1) with one or more thermoplastic polymers (component K2), for example polyphenylene ethers (PPE), polyamides (PA), polyolefins, such as polypropylene (PP) or polyethylene (PE), polyacrylates, such as polymethyl methacrylate (PMMA), polycarbonates (PC), polyesters, such as polyethylene terephthalate (PET) or polybutylene terephthalate (PBT), polyether sulfones (PES), polyether ketones (PEK), or polyether sulfides (PES). Polyamide (PA) is a preferred thermoplastic polymer.

The polymers mentioned for component K1 are obtainable by polymerizing one or more vinylaromatic monomers, such as styrene and oc-methylstyrene, and, if desired, further comonomers, such as dienes, α,β-unsaturated carboxylic acids, esters (preferably alkyl esters), or amides of these carboxylic acids, and alkenes.

The vinylaromatic monomer used preferably comprises at least one compound of the general formula (I),

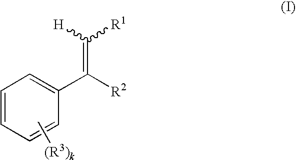

in which each of R¹ and R², independently of the other, is hydrogen, methyl, or ethyl;

R³ is hydrogen, C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; preferably C₁-C₄-alkyl, such as methyl, ethyl, n-propyl, isopropyl, n-butyl, isobutyl, sec-butyl and tert-butyl; and

k is a whole number from 0 to 2.

It is preferable that each of R¹ and R² is hydrogen, and it is further preferable that k=0. Particular preference is given to styrene; other particularly suitable compounds are α-methylstyrene, p-methylstyrene, ethylstyrene, tert-butylstyrene, vinylstyrene, vinyltoluene, 1,2-diphenylethylene, 1,1-diphenylethylene, or a mixture of these.

Diene comonomers that can be used are any of the polymerizable dienes, in particular 1,3-butadiene, 1,3-pentadiene, 1,3-hexadiene, 2,3-dimethylbutadiene, isoprene, piperylene or a mixture of these. Preference is given to 1,3-butadiene (abbreviated to: butadiene), isoprene, or a mixture of these.

Preferred suitable α,β-unsaturated carboxylic acids or their derivatives are compounds of the general formula (II),

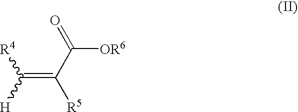

in which the definitions of the symbols are as follows:

R⁵ is selected from the group consisting of
unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl, and tert-butyl;
or hydrogen,
very particular preference being given to hydrogen and methyl;

R⁴ is selected from the group consisting of
unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl, and tert-butyl;
very particular preference being given to hydrogen;

R⁶ is selected from the group consisting of
hydrogen (whereby compound (II) is the carboxylic acid itself),
unbranched or branched C₁-C₁₀-alkyl (whereby compound II is a carboxylic ester), such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl, and tert-butyl; and also 2-ethylhexyl.

Preferred compounds of the formula (II) are acrylic acid and methacrylic acid. Preference is further given to the C₁-C₁₀-alkyl esters of acrylic acid, in particular the butyl esters, preferably n-butyl acrylate, and to the C₁-C₁₀-alkyl esters of methacrylic acid, in particular methyl methacrylate (MMA).

Suitable carboxamides are in particular the amides of the abovementioned compound (II), for example acrylamide and methacrylamide.

Other monomers that can be used are compounds of the general formula (IIIa) and (IIIb), the compounds (IIIa) formally being OH-substituted carboxamides:

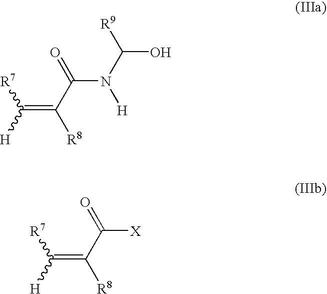

in which the definitions of the symbols are as follows:

R⁸ is selected from the group consisting of
unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl and tert-butyl; or hydrogen;
very particular preference being given to hydrogen and methyl;

R⁷ is selected from the group consisting of
unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dirnethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl and tert-butyl.
very particular preference being given to hydrogen;

R⁹ is selected from the group consisting of
unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl and tert-butyl;
very particular preference being given to hydrogen;

X is selected from the group consisting of
hydrogen,
glycidyl
groups having tertiary amino groups, preferably NH(CH₂)_{b}—N(CH₃)₂, where b is a whole number in the range from 2 to 6,
enolizible groups having from 1 to 20 carbon atoms, preferably acetoacetyl of the formula

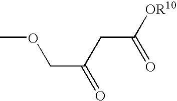

where

R¹⁹ is selected from unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particular preference being given to C₁-C₄-alkyl, such as methyl, ethyl, n-propyl, isopropyl, n-butyl, isobutyl, sec-butyl, and tert-butyl.

It is very particularly preferable that R⁸ in the formula (IIIa) or (IIIb) has been selected from hydrogen and methyl, and that each of R⁷ and R⁹ is hydrogen.

Methylolacrylamide is particularly preferred as compound of the formula (IIIa).

The EPS can also be produced using alkenes as comonomers. Particularly suitable alkenes are ethylene (ethene) and propylene (propene).

Examples of further suitable comonomers for the production of component K1 are from 1 to 5% by weight of any of the following: (meth)acrylonitrile, (meth)acrylamide, ureido(meth)acrylate, 2-hydroxyethyl (meth)acrylate, 3-hydroxypropyl (meth)acrylate, acrylamidopropanesulfonic acid (branched or unbranched) or the sodium salt of vinylsulfonic acid.

The EPS bead material can be produced by known processes familiar to the person skilled in the art, for example by

V1 suspensions polymerization of styrene or of other vinylaromatic monomers or comonomers in the presence of blowing agents, thus immediately producing EPS bead material comprising blow agent,

V2 impregnation of polystyrene bead material comprising no blowing agent with the blowing agent under pressure in a heated suspension, where the blowing agent diffuses into the softened bead material (and EPS bead material comprising blow agent is obtained when the suspension is cooled under pressure), or

V3 mixing to incorporate the blowing agent into a polystyrene melt by means of an extruder or any other mixing apparatus (the melting comprising blowing agent being discharged under pressure and, for example, pelletized by underwater pelletization to give EPS bead material).

The EPS bead material obtainable by one of the processes V1, V2, or V3 can be isolated, washed, and dried by conventional processes.

Compact EPS bead material and prefoamed EPS bead material are suitable as inventive EPS bead material (preference being given to prefoamed EPS bead material).

Suitable blowing agents are the physical blowing agents usually used in EPS bead material, examples being aliphatic hydrocarbons having from 2 to 8 carbon atoms, alcohols, ketones, ethers, or halogenated hydrocarbons, or water, or a mixture of these. It is preferable to use isobutane, n-butane, isopentane, n-pentane, or a mixture of these.

The amount used of the blowing agent is from 0.5 to 15% by weight, preferably from 1 to 10% by weight, and in particular from 2 to 8% by weight, based on the vinylaromatic monomer used.

The EPS can comprise further additives. According to the invention, the term additives is used as a collective term for auxiliaries which are used during the polymerization reaction, preferably during the suspension polymerization reaction, examples being nucleating agents, plasticizers, flame retardants, IR absorbers, such as carbon black, graphite, aluminum powders, titanium dioxide, soluble and insoluble dyes, and pigments. Preferred additives are graphite and carbon black. The preferred content of graphite is from 0.05 to 25% by weight, particularly preferred from 2 to 8% by weight, respectively based on the total weight of the EPS. The average size of the graphite particles is preferably from 1 to 50 μm, particularly preferred from 2 to 10 μm.

In one embodiment the EPS according to the invention is colored to allow a simple distinction from non-insecticide-modified EPS and, thereby, to improve product safety during production and processing.

Because of the fire-protection regulations in the construction industry and in other industries, the inventive EPS preferably comprises one or more flame retardants.

An example of a suitable flame retardant is hexabromocyclododecane (HBCD), in particular the technical-grade products which essentially consist of the α-, β-, and γ-isomer and preferably of dicumyl peroxide added as synergist.

Further suitable flame retardants are for example tetrabromobisphenol-A-diallyl ether, expandable graphite, red phosphorous, triphenyl phosphate and 9,10-dihydro-9-oxa-10-phosphaphenanthren-10-oxide.

According to the invention, the EPS bead material comprises a coating comprising
(A) one or more insecticides
(B) one or more glycerol esters
(C) if desired, one or more binders, and
(D) if desired, further additives.

The term “insecticide” for the purposes of the invention embraces arthropodicides (insecticides and acaricides) and nematicides.

Suitable insecticides are known in principle to the skilled person and are described in C.D.S. Tomlin (ed.), The Pesticide Manual, 14th edition, The British Crop Protection Council, 2006, for example.

Preference is given to insecticides from the following group:

I.1. GABA antagonist compounds: acetoprole, endosulfan, ethiprole (III), fipronil (II), vaniliprole, pyrafluprole, pyriprole; phenylpyrazole compound of the formula (VI) (see below);

I.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

I.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;

I.4. Growth regulators: a) chitin synthesis inhibitors: benzoylureas: chlorfluazuron, diflubenzuron, flucycloxuron, flufenoxuron, hexaflumuron, lufenuron, novaluron, noviflumuron, sulfluramid, teflubenzuron, teflumoron, buprofezin, diofenolan, hexythiazox, etoxazole, clofentazine; b) ecdysone antagonists: haliofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;

I.5. Nicotin receptor agonist/antagonist compounds: acetamiprid, clothianidin, dinotefuran, imidacloprid, nitenpyram, thiacloprid, thiamethoxam;

I.6. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isofenphos, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, tolazophos, trichlorfon;

I.7. Macrocyclic lactone insecticides: abamectin, emamectin, milbemectin, lepimectin, spinosad;

I.8. Site-I electron transport inhibitors: for example, fenazaquin, pyridaben, tebufenpyrad, tolfenpyrad;

I.9. Site-II and site-Ill electron transport inhibitors:

acequinocyl, fluacyprim, hydramethylnon (V);

I.10. Uncoupler compounds: chlorfenapyr (VI);

I.11. Oxidative phosphorylation inhibitor compounds: cyhexatin, diafenthiuron, fenbutatin oxide, propargite;

I.12. Chitin biosynthesis inhibitors:

cyromazine;

I.13. Mixed function oxidase inhibitor compounds:

piperonyl butoxide;

I.14. Sodium channel modulators:

indoxacarb, metaflumizone;

I.15. Active substances with unknown or nonspecific mechanisms of action:

benclothiaz, bifenazate, borate, cartap, chlorantraniliprole, flonicamid, pyddalyl, pymetrozine, sulfur, thiocyclam, flubendiamide, cyenopyrafen, cyflumetofen, flupyrazofos, amidoflumet.

The commercially available compounds of group 1.1 to 1.15 can be found in “The Pesticide Manual”, 14th edition, British Crop Protection Council, (2006).

Lepimectin is known from “Agro Project”; PJB Publications Ltd, November 2004. Benclothiaz and its preparation are described in EP-A1 454621. Methidathion and paraoxon and their preparation are described in “Farm Chemicals Handbook”; volume 88, Meister Publishing Company, 2001. Acetoprole and its preparation are described in WO 98/28277. Flupyrazofos is described in “Pesticide Science” 54, 1988, pages 237-243 and in U.S. Pat. No. 4,822,779. Pyrafluprole and its preparation are described in JP 2002193709 and in WO 01/00614. Pyriprole and its preparation are described in WO 98/45274 and in U.S. Pat. No. 6,335,357. Amidoflumet and its preparation are described in U.S. Pat. No. 6,221,890 and in JP 21010907. Flufenerim and its preparation are described in WO 3/007717 and in WO 03/007718. Cyflumetofen and its preparation are described in WO 04/080180.

Further preferred insecticides are amidrazones of the formula (IV),

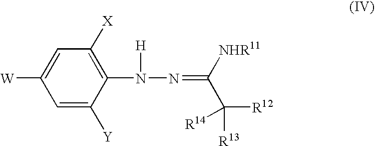

where the symbols have the following definition:

W is Cl or CF₃;

X, Y are identical or different and are Cl or Br;

R¹¹ is (C₁-C₆)-alkyl, (C₃-C₆)-alkenyl, (C₃-C₆)-alkynyl or (C₃-C₆)-cycloalkyl, which may be substituted by 1 to 3 halogen atoms, or (C₂-C₄)-alkyl which is substituted by (C₁-C₄)-alkoxy;

R¹², R¹³ are (C₁-C₆)-alkyl or, together with the carbon atom to which they are attached, form (C₃-C₆)-cycloalkyl, which may be substituted by 1 to 3 halogen atoms;

R¹⁴ is H or (C₁-C₆)-alkyl,

and also enantiomers and salts thereof.

The symbols preferably have the following definitions in the formula (IV):

R¹¹ is preferably (C₁-C₄)-alkyl, more particularly methyl or ethyl;

R¹² and R¹³ are preferably methyl or, with the carbon atom to which they are attached, form a cyclopropyl ring which may carry one or two chlorine atoms;

R¹⁴ is preferably (C₁-C₄)-alkyl, more particularly methyl;

W is preferably CF₃;

X, Y are preferably Cl.

Further-preferred compounds of the formula (IV) are those in which X and Y are Cl, W is CF₃, R¹², R¹³ and R¹⁴ are methyl and R¹¹ is methyl or ethyl, and also those compounds in which X and Y are Cl, W is CF₃, R¹² and R¹³, together with the carbon atom to which they are attached, form a 2,2-dichlorocyclopropyl group, R¹⁴ is methyl and R¹¹ is methyl or ethyl. These compounds and their preparation are described in US 2007/0184983, for example.

Particular preference is given to insecticides from the following group:
I.1 Acetoprole, ethiprole (III), fipronil (II), vaniliprole;
I.2 Carbaryl;
I.3 Bifenthrin, cyfluthrin, cyhalothrin, cypermethrin, alpha-cypermethrin, deltamethrin, fenvalerate, lambda-cyhalothrin, permethrin;
I.4 Diflubenzuron, flufenoxuron, hexaflumuron, noviflumuron, sulfluramid;

I.5 Acetamiprid, imidacloprid, thiacloprid, thiamethoxam;

I.6 Chlorpyrifos, fenitrothion, isofenphos;

I.7 Spinosad;

I.8. Site-I electron transport inhibitors: for example, fenazaquin, pyridaben, tebufenpyrad, tolfenpyrad;

I.9. Hydramethylnon (V);

I.10. Chlorfenapyr (VI);

I.11. The oxidative phosphorylation inhibitor compounds: cyhexatin, diafenthiuron, fenbutatin oxide, propargite;

I.12. Chitin biosynthesis inhibitors:

cyromazine;

I.13. Mixed function oxidase inhibitor compounds:

piperonyl butoxide;

I.14. Indoxacarb, metaflumizone;

I.15. Borates, chlorantraniliprol, flonicamid;

Very particular preference is given to insecticides from the group of the phenylpyrazoles, preferably fipronil (V), acetoprole, ethiprole (VI), and the compound of the formula (VII) (more particularly preferred fipronil), chlorfenapyr (VIII), and hydramethylnon (IX)

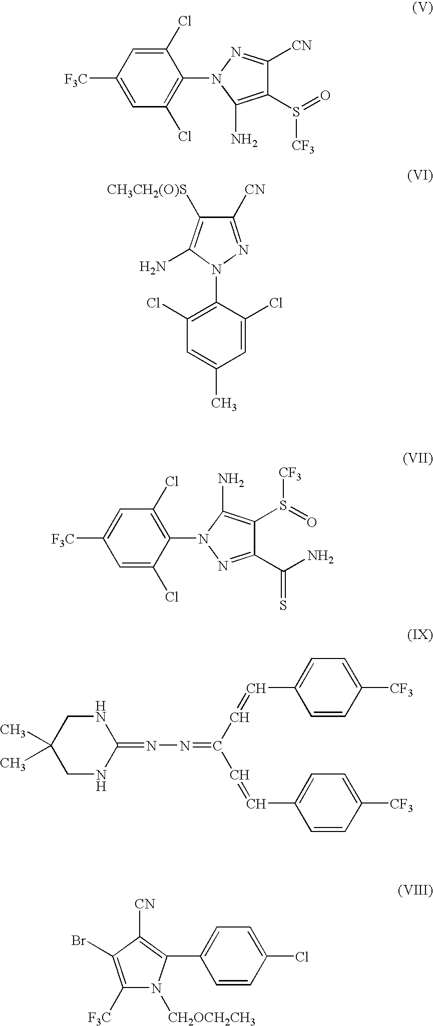

More particular preference is given to fipronil.

Preferred co-components for fipronil are pyrethroids (I.3), nicotine receptor agonists/antagonists (I.5), borate, carbaryl, chlorantraniliprole, chlorpyrifos, diflubenzuron, fenitrothion, flonicamid, flufenoxuron, hexaflumuron, indoxacarb, isofenphos, noviflumuron, metaflumizone, spinosad, sulfluramid. Particular preference is given to acetamiprid, bifenthrin, cyfluthrin, cyhalothrin, cypermethrin, alpha-cypermethrin, deltamethrin, fenvalerate, imidacloprid, lambda-cyhalothrin, permethrin, thiacloprid and thiamethoxam.

The ratio of mixing between the insecticides used according to the invention and any further participants in the mixture can vary widely and is generally from 0.1:100 to 100:0.1.

The insecticide can be used undiluted (e.g. in the form of technical-grade or pure active ingredient). It is also possible to use the types of formulations that are available commercially.

Suitable concentrations of the insecticide or of the insecticide mixture, based on the EPS, are selected in such a way that the moldings obtainable therefrom have concentrations of from 10 to 1000 ppm, particularly preferably from 20 to 1000 ppm, and very particularly preferably from 50 to 500 ppm.

The inventive coating can comprise a binder alongside the insecticide. Examples of suitable polymeric binders are acrylate resins, aqueous polymer dispersions, or waxes. Polymer dispersions are particularly preferred. The polymer dispersions are obtainable from the monomers indicated for the production of component K1. It is moreover possible to make concomitant use of comonomers for the production of the polymer dispersion, examples being from 1 to 5% by weight of any of the following: (meth)acrylonitrile, (meth)acrylamide, ureido(meth)acrylate, 2-hydroxyethyl (meth)acrylate, 3-hydroxypropyl (meth)acrylate, acrylamidpropanesulfonic acid (branched or unbranched) or the sodium salt of vinylsulfonic acid. The polymer dispersion can also be produced with use of alkenes. Suitable alkenes are particularly ethylene (ethene) and propylene (propene).

A homopolymer can be used, an example being a dispersion of polyethylene or polypropylene, or—preferably—alkene-containing copolymers can be used. Examples of those with good suitability are copolymers composed of propylene and carboxylic acids or carboxylic compounds of the above formula I, examples being acrylic acid or methacrylic acid, or the alkyl acrylates or alkyl methacrylates mentioned. Products of this type are obtainable, for example, as Poligen® from BASF. An example of a suitable polymer dispersion is a dispersion composed of propylene-alkyl acrylate copolymer.

Preferred aqueous polymer dispersions comprise a polymer based on
i) styrene,
ii) n-butyl acrylate, MMA, methacrylic acid, acrylamide, and methylolacrylamide,
iii) styrene and the monomers mentioned in ii)

The polymer dispersion is produced by known methods familiar to the person skilled in the art, for example by emulsion polymerization, suspension polymerization, or dispersion polymerization in the liquid phase.

The polymer dispersion can be uncrosslinked or crosslinked and its glass transition temperature is preferably from −60 to +140° C., in particular from −20 to +80° C. (determined by means of differential scanning analysis (DSC)).

In selecting the binder it has proven advantageous to use those which do not lead to adhesion of the EPS bead material to be coated, for example EPS pellets or prefoamed EPS beads. In order to meet these requirements, it is preferable to use those binders whose film-forming temperature (MFT) is from −20 to +45° C., in particular from −5 to 35° C.

Further suitable binders are waxes, such as polyethylene waxes, oxidized polyethylene waxes, ethylene copolymer waxes, montan waxes, and polyether waxes.

As far as the amount to be used of binder is concerned, a suitable method has been found to be use of from 0.005 to 4.0% by weight of binder to coat the EPS bead material. The amount of binder preferably used to coat the EPS bead material is from 0.01 to 2.0% by weight, based on the weight of the coated EPS bead material (where the % by weight data are based on the solids content of the binder used for the coating procedure).

The glycerol ester selected comprises at least one compound of the general formula (X)

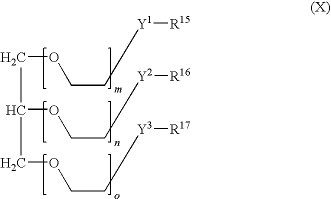

in which the definitions of the symbols and indices are as follows:

m, n, and o, independently of one another, are whole numbers from 0 to 10;

Y¹, Y², and Y³, independently of one another, are —O—, —S—, or —NR¹⁶—;

R¹⁸ is hydrogen or C₁-C₁₀-alkyl;

R¹⁵, R¹⁶, and R¹⁷, independently of one another, are hydrogen, —SO R¹⁹, —SO₂ R¹⁹, —SO₃ R¹⁹ or —COR¹⁹;

R¹⁹ is hydrogen, C₁-C₃₀-alkyl, where the alkyl radical is straight-chain or branched, saturated, or comprises one or more C—C double or C—C triple bonds and is unsubstituted or substituted with one or more radicals from the group of hydroxy, oxo, and COOR²⁰ (where R²⁰ is C₁-C₆-alkyl).

It is preferable that m, n and o are zero, Y¹, Y², and Y³ are —O—, and R¹⁵, R¹⁶, and R¹⁷, independently of one another, are hydrogen, formyl, acetyl, propionyl, butyryl, isobutyryl, valeryl, isovaleryl, pivaloyl, caproyl, capryloyl, decanoyl, lauroyl, myrisitoyl, palmitoyl, stearoyl, 12-hydroxystearoyl, arachidoyl, behenoyl, lignoceroyl, cerotinoyl, mellisoyl, oleyl, ricinoleoyl, erucoyl, sorboyl, linoleoyl, linolenoyl, or eleostearoyl.

It is therefore particularly preferable that m, n and o are zero, Y¹, Y², and Y³ are —O—, and R¹⁵, R¹⁶, and R¹⁷, independently of one another, are hydrogen, lauroyl, myrisitoyl, palmitoyl, stearoyl, 12-hydroxystearoyl, oleyl, ricinoleoyl, erucoyl, sorboyl, linoleoyl, or linolenoyl.

Particular preference is further given to the mono-, di-, and triglycerides which are obtainable from glycerol and from stearic acid, glycerol and 12-hydroxystearic acid, and glycerol and ricinoleic acid, and also to mixed di- and triglycerides which are obtainable from, alongside stearic acid, 12-hydroxystearic acid, and ricinoleic acid, one or more fatty acids from the group of oleic acid, linoleic acid, linolenic acid, and palmitic acid.

Particular preference is also given to the corresponding commercially available products, which are generally mixtures of the corresponding mono-, di-, and triesters, which can also comprise small proportions of free glycerol and of free fatty acids, examples being castor oil and downstream products obtainable by partial or complete hydrogenation of castor oil, e.g. castor wax.

As far as the amount used of glycerol ester is concerned, a suitable method has been found to use from 0.01 to 1.0% by weight of glycerol ester to coat the EPS. It is preferable that the EPS is coated with from 0.1 to 0.6% by weight of glycerol ester, in particular with from 0.2 to 0.5% by weight of glycerol esters, based on the weight of the coated EPS bead material.

The coating can comprise further additives, such as antistatic agents, hydrophobizers, flame retardants, finely divided silica, and inorganic fillers. The proportion of these agents depends on their type and action and in the case of inorganic fillers is generally from 0 to 10% by weight, based on the coated EPS bead material.

Suitable coating compounds are amphiphilic or hydrophobic organic compounds. Among the hydrophobic organic compounds C₁₀-C₃₀ paraffin wax, reaction products of a C₉-C₁₁ oxoalcohol with ethylene oxide, propylene oxide or butylene oxide or polyfluoro alkyl(meth)acrylate or mixtures thereof are particularly mentioned, which can preferably be used in the form of aqueous emulsions.

Preferred hydrophobing agents are paraffin waxes with 10 to 30 C-atoms in the carbon chain, which preferably have a melting point between 10 to 70° C., particularly between 25 and 60° C. Such paraffin waxes are contained for example in the BASF-commercial products Ramasit® KGT, Persistol® E and Persistol® HP, and in Aversin® HY-N from Henkel and Cerol® ZN from Clariant.

Another group of suitable hydrophobing agents are resinlike reaction products of a N-methylol amine with a fatty acid derivative, for example a fatty acid amide, fatty amine or fatty alcohol, as described for example in U.S. Pat. No. 2,927,040 or GB-A 475 170. Their melting points are normally at 50 to 90° C. Such resins are contained for example in the BASF-commercial products Persistol® HP.

Finally polyfluoro alkyl(methyl) acrylates are also suitable, for example polyperfluoro octyl acrylate. This substance is contained in the BASF-commercial product Persistol® O and in Oleaphobol® from Pfersee.

Suitable amphiphilic coating compounds are antistatics, such as Emulgator K30 (mixture of secondary sodium alkane sulfonates) or glyceryl stearates, such as glyceryl monostearate or glyceryl tristearate.

The coating is applied to the EPS bead material, which by way of example is obtainable by the processes V1, V2, and V3 described. The coating procedure can take place directly after the production of the EPS bead material without prior drying, or after work-up and drying, onto compact EPS bead material or onto prefoamed EPS bead material. It is preferable that the coating procedure takes place after work-up and drying of compact EPS bead material or of prefoamed EPS bead material.

Application of (A) insecticides, (B) glycerol ester and, if desired, (C) binder, and (D) further additives can take place in any desired sequence in succession, or simultaneously.

The coating components here can be present in solution and/or dispersion (e.g. suspension or emulsion). As a function of the nature and amount of the components, simple stirring can be used for this purpose. If components have poor miscibility (poor dispersibility), elevated temperatures and/or pressures, and also, if appropriate, specific mixing apparatuses, can be required in order to achieve uniform mixing. If necessary, auxiliaries which facilitate the mixing process can be used concomitantly, examples being conventional wetting agents. The coating composition obtained can moreover be stabilized by addition of suitable additives, e.g. familiar protective colloids or antisettling agents, to prevent demixing.

In one preferred embodiment, binders, glycerol esters, and one or more insecticides are mixed with one another prior to the coating procedure and then applied to the EPS bead material to be coated.

In a further particular embodiment, one or more insecticides and the binder are first applied in succession or simultaneously to the EPS bead material. Coating with the glycerol ester then takes place.

In a further particular embodiment, the binder is not applied to the EPS bead material to be coated until coating with the insecticide (in formulated form or in pure form) and the glycerol ester has taken place.

It is also possible to apply the coating components to the EPS to be coated by spraying or application in conventional drum mixers. Also possible is the immersion or wetting of the EPS bead material to be coated in a suitable solution, dispersion, emulsion, or suspension.

Conventional mixers, spray apparatuses, or drum apparatuses are used for this purpose.

In a particular embodiment the EPS bead material is produced by extrusion of a polystyrene melt containing a blowing agent through a die plate followed by underwater granulation, wherein the coating of the EPS-granulate is carried out by water soluble, emulsified or suspended coating compounds in the water cycle of the underwater granulator.

After or during the coating procedure using a coating composition which is liquid (or which comprises solvent), the EPS bead material can also be dried using air at room temperature or slightly elevated temperature. The temperature is preferably selected in such a way as to prevent any unintended softening of the EPS bead material and any escape of the blowing agent.

When EPS bead material which has not been prefoamed is coated, the average bead size of the coated EPS bead material is generally from 0.1 to 3.0 mm, in particular from 0.3 to 2.0 mm.

A masterbatch can moreover be used for the coating process. For this, EPS bead material which has not been prefoamed, or which has been prefoamed, is coated with a markedly higher concentration of insecticide.

This masterbatch can then be mixed in a suitable mixing ratio, preferably from 1:1000 to 1:000:1, with further EPS bead material, and then foamed in the manner described.

It is moreover possible to produce masterbatches of EPS bead material (EPS bead material which has not been prefoamed or EPS bead material which has been prefoamed) where each masterbatch has been coated with one or more different insecticides. These EPS bead materials coated with different insecticides can be mixed with one another and used for the production of foam products with at least two different insecticides.

The invention also provides a process for the production of moldings, obtainable from the inventively coated EPS bead material.

For the production of moldings from the inventive EPS bead material, this can be used in pure form or in a mixture with further EPS bead material, in particular insecticide-free EPS bead material.

The mixing ratio of inventive and further EPS bead material here can be varied freely, but is preferably selected in such a way that the moldings produced have concentrations of from 10 to 1000 ppm, particularly preferably from 20 to 1000 ppm, and very particularly preferably from 50 to 500 ppm.

Mixing ratios of inventive EPS bead material to further EPS bead material are preferably from 1000:1 to 1:1000, particularly preferably from 100:1 to 1:100, very particularly preferably from 50:1 to 1:50, and in particular from 10:1 to 1:20.

It is preferable to begin by producing blocks as molding and then to divide the blocks to give foam sheets, for example by cutting or sawing.

The thickness of the foam sheets can vary widely and is usually from 1 to 500 mm, preferably from 10 to 300 mm. The length and width of the sheets can likewise be varied widely. It is limited inter alia by the size of the mold (compression or foaming mold) and, in the case of press molding (see below), by the locking force of the press used.

It is further preferable that the moldings are semifinished products (sheets, pipes, rods, profiles, etc.) or other moldings of simple or complex shape.

The invention further provides a process for the production of inventive moldings with a homogeneous distribution of the insecticide. For this, known methods familiar to the person skilled in the art are used, in a first step a) partially prefoaming the EPS bead material preferably by means of hot air or steam, and in a second step b) fusing it to give the inventive moldings. The fusion can be brought about by foaming-to-completion (foaming-to-completion process) or press molding (press molding process).

In the foaming-to-completion process, which is preferred, in step i) the inventive prefoamed EPS bead material is charged to a gastight mold. The term gastight is not intended to exclude the possibility that small amounts, for example up to 10% by volume, of the gas volume present in the mold or of the gas volume produced during the process of foaming-to-completion may escape from the mold.

The geometry (three-dimensional shape) of the gastight mold usually corresponds to the desired geometry of the subsequent molding. For foam sheets, for example, a simple box-shaped mold is suitable. The blocks obtained can then be divided by sawing to give sheets. In the case of complicated shapes, it can be necessary to compact the bead material loosely charged to the mold, as described for the press molding process (see below).

Since the beads are intended to fuse to one another during the subsequent foaming-to-completion process, it is advantageous to fill the mold up to its brim with the beads, so as to minimize the unfilled volume in the mold.

In step ii), the charge of bead material in the closed mold is foamed to completion by controlling the temperature of the material to from 60 to 120° C., preferably from 70 to 110° C. (for example using steam or any other heat-transfer medium). The beads fuse here to give the molding, in that the interstices in the loose bead material are filled by the expanding beads, and the softened beads “fuse” with one another.

The pressure during the foaming-to-completion processes is not usually critical, and is generally from 0.05 to 2 bar. The duration of the foaming-to-completion process depends inter alia on the size and shape of the molding and also on its desired density, and can vary widely.

In step iii) of the foaming-to-completion process, the resultant molding is removed from the mold, and this can take place manually or automatically by means of conventional ejector apparatuses or demolding apparatuses.

The inventive process for the production of the moldings where fusion b) is undertaken by foaming-to-completion therefore encompasses the steps of:
i) charging the prefoamed EPS bead material according to the invention to a gastight mold,
ii) fusing the charge of bead material by controlling its temperature to from 60 to 120° C., whereupon, by foaming, the bead material fuses to give a molding, and
iii) removing the resultant molding.

The density of the moldings obtained by this foaming-to-completion process is usually from 10 to 100 g/l, preferably from 15 to 80 g/l, and particularly preferably from 15 to 60 g/l, determined to DIN 53420. The moldings preferably do not have any pronounced density gradients, i.e. the density of the peripheral layers is not markedly higher than that of the inner regions of the molding.

In the press molding process, in step I), the inventive prefoamed EPS bead material is charged to a gas-permeable mold. The gas permeability can, for example, be achieved through holes which are provided in the mold and which are preferably such that they are not blocked by the polymer (see below) during the subsequent press molding process (step II), for example because they are of low diameter.

The shape (three-dimensional shape) of the gas-permeable mold generally corresponds to the desired shape of the subsequent molding. If the intention is to produce foam sheets, a simple box-shaped mold can be used. In particular for complicated shapes, it can be necessary to compact the bead material charged to the mold and thus eliminate undesired cavities. Examples of methods for compaction here are shaking of the mold, tumbling movements, or other suitable measures.

Since the bead material is then pressed, it is not—unlike the process described at a later stage below for foaming-to-completion—preferable, but nor is it disadvantageous, that the mold be filled to its brim with the bead material. The fill level depends inter alia on the desired thickness of the subsequent molding.

In step II), the charge of bead material is pressed to give a molding, with volume reduction. The volume reduction is generally from 1 to 80% by volume, preferably from 5 to 60% by volume, and in particular from 10 to 50% by volume, based on the volume of the charge of bead material prior to the pressure process.

The temperature during the pressure process is usually from 20 to 100° C., preferably from 30 to 90° C., and in particular from 40 to 80° C. Examples of the method of temperature control are electric heating or heat-transfer media. The pressure maximum during the compression procedure, or the locking force of the press, and also the duration of the press molding process (press time) depend inter alia on the size and shape of the molding, and also on its desired density, and can be varied widely.

The gas-permeability of the mold ensures that blowing agent, air, or other gases present in and between the particles can escape uniformly during the press molding process. To the extent that the coated bead material has been used in a form which has not been dried but has a “moist” coating, the volatile auxiliaries also escape, an example being the water comprised in the coating composition.

Conventional presses using pressure mold and ram, for example multi-daylight presses, are suitable for the press molding process. The temperature of the mold or of the ram, or of both components, can be controlled here.

In step III) of the press molding process, the resultant molding is removed from the mold. This can take place manually or automatically by means of suitable ejector apparatuses or demolding apparatuses.

The inventive process for the production of a molding where fusion b) is undertaken by press molding therefore encompasses the steps of:
I) charging the prefoamed bead material defined according to the invention to a gas-permeable mold,
II) in the closed mold, press molding of the charge of bead material, with volume reduction, to give a molding
III) removing the resultant molding.

The density of the moldings obtained by this press molding process is generally from 8 to 120 g/l, preferably from preferably from 20 to 100 g/l, and particularly preferably from 20 to 70 g/1 to DIN 53420. The moldings preferably do not have any pronounced density gradient, i.e. the density of the peripheral layers is not markedly higher than that of the inner regions of the molding.

Typical dimensions of the foam sheets obtainable by the press molding process or foaming-to-completion process have been mentioned above.

Further information concerning conventional polymerization, impregnation, and foaming processes are found by way of example in Kunststoffhandbuch [Plastics Handbook], volume 5, Polystyrol [Polystyrene], edited by R. Vieweg and G. Daumiller, Carl Hanser Verlag Munich 1969.

The invention further provides the use of the inventive moldings in the construction industry, for example as insulation material above or below the ground, for avoidance or mitigation of the damage caused to these moldings by pests, for example insects, consumption by which can cause substantial damage to the moldings, thus compromising the insulating action of the moldings and also their mechanical stability, and so permitting further encroachment by the pests.

The inventive moldings can be used advantageously in moldings which are constantly exposed to water, for example for plates for roof isolation or perimeter insulation, for floating bodies or water sensitive packaging materials such as boxes for fish.

The inventive moldings are particularly suitable for avoidance or mitigation of damage caused by termites.

The invention therefore also provides the use of the inventive moldings for the protection of buildings from termites, and a process for the protection of a building from termites, wherein the inventive moldings are incorporated into the base, the outwalls or the roof of the building to be protected.

The invention is further illustrated by the examples, without being restricted thereto.

### EXAMPLES

### 1. Starting Materials

a) EPS

The EPS used comprised F 295 raw product.
b) Insecticide component

The insecticide component (A) used comprised an aqueous fipronil formulation prepared by milling and mixing of 500 g of fipronil, 25 g of an ethoxylated phosphate ester salt, 10 g of a tridecyl alcohol ethoxylate (whose HLB is 12), 10 g of a dye (Rubin Toner 2BO), 2.5 g of a thickener (xanthan gum), and using water to make up the volume to 1 l.
c) Binder

B1 Acronal® S728=aqueous styrene/acrylate dispersion (BASF SE),

B2 Acronal® LR 8977=aqueous self-crosslinking copolymer dispersion (butacrylate/styrene) (BASF SE),

B3 Acronal® S 760=aqueous self-crosslinking copolymer dispersion (butacrylate/styrene) (BASF SE),

B4 Styronal® D 628=aqueous copolymer dispersion (styrene/acrylonitrile/butadiene) (BASF SE),

B5 Acronal® S 504=aqueous dispersion of an acrylate copolymer with concomitant use of acrylonitrile (BASF SE)

B6 Styronal® D 537=aqueous copolymer dispersion (styrene/butadiene) (BASF SE),
d) Glycerol ester

A glycerol ester (C) used comprised glycerol stearate.

### 2. Production of the Inventive EPS Bead Material

200 g of EPS pellets are mixed for 30 seconds at room temperature in a Sumakon mixer at 200 rpm (scraper 40 rpm) with a mixture of the fibronil formulation (A), and with a binder (B), and glycerol ester (C) plus at a time 0,04 weight percent silicate (FK 320 from Degussa)

### 3. Performance Tests

Table 1 and Table 1a show the constitution of the inventive EPS bead material produced:

TABLE 1

| | | Fipronil | | | | | | | Glycerol |
|---|---|---|---|---|---|---|---|---|---|
| | EPS | formulation (A) | E1 | E2 | E3 | E4 | E5 | E6 | ester (C) |
| Example | [g] | [g] | [g] | [g] | [g] | [g] | [g] | [g] | [g] |
| 1 | 198.5 | 0.27 | 0.25 | — | — | — | — | — | 0.4 |
| 2 | 198.5 | 0.55 | 0.25 | — | — | — | — | — | 0.4 |
| 3 | 198.5 | 0.11 | 0.25 | — | — | — | — | — | 0.4 |
| 4 | 198.5 | 0.21 | 0.24 | — | — | — | — | — | 0.4 |
| 5 | 198.5 | 0.27 | 0.5 | — | — | — | — | — | 0.4 |
| 6 | 198.5 | 0.55 | 0.5 | — | — | — | — | — | 0.4 |
| 7 | 198.5 | 0.11 | 0.5 | — | — | — | — | — | 0.4 |
| 8 | 198.5 | 0.21 | 0.5 | — | — | — | — | — | 0.4 |
| 9 | 198.5 | 0.27 | 0.75 | — | — | — | — | — | 0.4 |
| 10 | 198.5 | 0.55 | 0.75 | — | — | — | — | — | 0.4 |
| 11 | 198.5 | 0.11 | 0.75 | — | — | — | — | — | 0.4 |
| 12 | 198.5 | 0.21 | 0.75 | — | — | — | — | — | 0.4 |
| 13 | 198.5 | 0.27 | — | 0.25 | — | — | — | — | 0.4 |
| 14 | 198.5 | 0.55 | — | 0.25 | — | — | — | — | 0.4 |
| 15 | 198.5 | 0.11 | — | 0.25 | — | — | — | — | 0.4 |
| 16 | 198.5 | 0.21 | — | 0.24 | — | — | — | — | 0.4 |
| 17 | 198.5 | 0.27 | — | 0.5 | — | — | — | — | 0.4 |
| 18 | 198.5 | 0.55 | — | 0.5 | — | — | — | — | 0.4 |
| 19 | 198.5 | 0.11 | — | 0.5 | — | — | — | — | 0.4 |
| 20 | 198.5 | 0.21 | — | 0.5 | — | — | — | — | 0.4 |
| 21 | 198.5 | 0.27 | — | 0.75 | — | — | — | — | 0.4 |
| 22 | 198.5 | 0.55 | — | 0.75 | — | — | — | — | 0.4 |
| 23 | 198.5 | 0.11 | — | 0.75 | — | — | — | — | 0.4 |
| 24 | 198.5 | 0.21 | — | 0.75 | — | — | — | — | 0.4 |
| 25 | 198.5 | 0.27 | — | — | 0.25 | — | — | — | 0.4 |
| 26 | 198.5 | 0.55 | — | — | 0.25 | — | — | — | 0.4 |
| 27 | 198.5 | 0.11 | — | — | 0.25 | — | — | — | 0.4 |
| 28 | 198.5 | 0.21 | — | — | 0.24 | — | — | — | 0.4 |
| 29 | 198.5 | 0.27 | — | — | 0.5 | — | — | — | 0.4 |
| 30 | 198.5 | 0.55 | — | — | 0.5 | — | — | — | 0.4 |
| 31 | 198.5 | 0.11 | — | — | 0.5 | — | — | — | 0.4 |
| 32 | 198.5 | 0.21 | — | — | 0.5 | — | — | — | 0.4 |
| 33 | 198.5 | 0.27 | — | — | 0.75 | — | — | — | 0.4 |
| 34 | 198.5 | 0.55 | — | — | 0.75 | — | — | — | 0.4 |
| 35 | 198.5 | 0.11 | — | — | 0.75 | — | — | — | 0.4 |
| 36 | 198.5 | 0.21 | — | — | 0.75 | — | — | — | 0.4 |
| 37 | 198.5 | 0.27 | — | — | — | 0.25 | — | — | 0.4 |
| 38 | 198.5 | 0.55 | — | — | — | 0.25 | — | — | 0.4 |
| 39 | 198.5 | 0.11 | — | — | — | 0.25 | — | — | 0.4 |
| 40 | 198.5 | 0.21 | — | — | — | 0.24 | — | — | 0.4 |
| 41 | 198.5 | 0.27 | — | — | — | 0.5 | — | — | 0.4 |
| 42 | 198.5 | 0.55 | — | — | — | 0.5 | — | — | 0.4 |
| 43 | 198.5 | 0.11 | — | — | — | 0.5 | — | — | 0.4 |
| 44 | 198.5 | 0.21 | — | — | — | 0.5 | — | — | 0.4 |
| 45 | 198.5 | 0.27 | — | — | — | 0.75 | — | — | 0.4 |
| 46 | 198.5 | 0.55 | — | — | — | 0.75 | — | — | 0.4 |
| 47 | 198.5 | 0.11 | — | — | — | 0.75 | — | — | 0.4 |
| 48 | 198.5 | 0.21 | — | — | — | 0.75 | — | — | 0.4 |
| 49 | 198.5 | 0.27 | — | — | — | — | 0.25 | — | 0.4 |
| 50 | 198.5 | 0.55 | — | — | — | — | 0.25 | — | 0.4 |
| 51 | 198.5 | 0.11 | — | — | — | — | 0.25 | — | 0.4 |
| 52 | 198.5 | 0.21 | — | — | — | — | 0.24 | — | 0.4 |
| 53 | 198.5 | 0.27 | — | — | — | — | 0.5 | — | 0.4 |
| 54 | 198.5 | 0.55 | — | — | — | — | 0.5 | — | 0.4 |
| 55 | 198.5 | 0.11 | — | — | — | — | 0.5 | — | 0.4 |
| 56 | 198.5 | 0.21 | — | — | — | — | 0.5 | — | 0.4 |
| 57 | 198.5 | 0.27 | — | — | — | — | 0.75 | — | 0.4 |
| 58 | 198.5 | 0.55 | — | — | — | — | 0.75 | — | 0.4 |
| 59 | 198.5 | 0.11 | — | — | — | — | 0.75 | — | 0.4 |
| 60 | 198.5 | 0.21 | — | — | — | — | 0.75 | — | 0.4 |
| 61 | 198.5 | 0.27 | — | — | — | — | — | 0.25 | 0.4 |
| 62 | 198.5 | 0.55 | — | — | — | — | — | 0.25 | 0.4 |
| 63 | 198.5 | 0.11 | — | — | — | — | — | 0.25 | 0.4 |
| 64 | 198.5 | 0.21 | — | — | — | — | — | 0.24 | 0.4 |
| 65 | 198.5 | 0.27 | — | — | — | — | — | 0.5 | 0.4 |
| 66 | 198.5 | 0.55 | — | — | — | — | — | 0.5 | 0.4 |
| 67 | 198.5 | 0.11 | — | — | — | — | — | 0.5 | 0.4 |
| 68 | 198.5 | 0.21 | — | — | — | — | — | 0.5 | 0.4 |
| 69 | 198.5 | 0.27 | — | — | — | — | — | 0.75 | 0.4 |
| 70 | 198.5 | 0.55 | — | — | — | — | — | 0.75 | 0.4 |
| 71 | 198.5 | 0.11 | — | — | — | — | — | 0.75 | 0.4 |
| 72 | 198.5 | 0.21 | — | — | — | — | — | 0.75 | 0.4 |

TABLE 1a

| | | Fipronil | | | Glycerol |
|---|---|---|---|---|---|
| | EPS | formulation (A) | | B4 | ester (C) |
| Example | [g] | [g] | Agent | [g] | [g] |
| 73 | 250 | 0.275 | fipronil | | 0.4 |
| | | | (Termidor SC) | | |
| 74 | 250 | 0.55 | | | 0.4 |
| 75 | 250 | 1.375 | | | 0.4 |
| 76 | 250 | 0.1 | deltamethrin | | 0.4 |
| | | | (25% WG | | |
| | | | formulation) | | |
| 77 | 250 | 0.5 | | | 0.4 |
| 78 | 250 | 1 | | | 0.4 |
| 79 | 250 | 1.5 | | | 0.4 |
| 80 | 250 | 0.036 | Imidacloprid | | 0.4 |
| | | | (70% WG | | |
| | | | formulation) | | |
| 81 | 250 | 0.178 | | | 0.4 |
| 82 | 250 | 0.36 | | | 0.4 |
| 83 | 250 | 0.25 | sodium borat | | 0.4 |
| | | | (technical grade) | | |
| 84 | 250 | 0.375 | | | 0.4 |
| 85 | 250 | — | — | | 0.4 |

### Homogeneity, Flowability, and Abrasion

The EPS pellets produced were assessed for homogeneity, pellet flowability, and abrasion. Abrasion was determined after 10 minutes of intensive shaking of 2 g of coated EPS pellets in a 10 ml glass cylinder. The amount of abraided material remaining in the glass container after removal of the pellets was determined gravimetrically:

The results are shown in table 2.

TABLE 2

| Example | Homogeneity | Flowability | Abrasion |
|---|---|---|---|
| 1 to 4 | Homogeneous | Very good | Very little (<0.5 ppt) |
| 5 to 8 | Homogeneous | Very good | Very little (<0.5 ppt) |
| 9 to 12 | Homogeneous | Very good | Very little (<0.5 ppt) |
| 13 to 16 | Homogeneous | Very good | Slight (<1 ppt) |
| 17 to 20 | Homogeneous | Good - very good | Slight (<1 ppt) |
| 21 to 24 | Homogeneous | Good - very good | Slight (<1 ppt) |
| 25 to 28 | Homogeneous | Good - very good | Very little (<0.5 ppt) |
| 29 to 32 | Homogeneous | Good | Very little (<0.5 ppt) |
| 33 to 36 | Homogeneous | Good | Very little (<0.5 ppt) |
| 37 to 40 | Homogeneous | Good - very good | Very little (<0.5 ppt) |
| 41 to 44 | Homogeneous | Good | Very little (<0.5 ppt) |
| 45 to 48 | Homogeneous | Good | Very little (<0.5 ppt) |
| 49 to 52 | Inhomogeneous | Good | Slight (<1 ppt) |
| 53 to 56 | Inhomogeneous | Poor | Slight (<1 ppt) |
| 57 to 60 | Inhomogeneous | Poor | Slight (<1 ppt) |
| 61 to 64 | Inhomogeneous | Good | Slight (<1 ppt) |
| 65 to 68 | Inhomogeneous | Poor | Slight (<2 ppt) |
| 69 to 72 | Inhomogeneous | Poor | Slight (<2 ppt) |

### Active Ingredient Content of Foam Produced

The active ingredient content was determined by means of GC/MS. For this, 0.5 g of EPS was dissolved in acetonitrile and an aliquot of this solution in dilute form was quantified by means of LC/MS/MS (Agilent GC: 6890N with an MS D 5973 detector).

Table 3 shows the results.

TABLE 3

Active ingredient content

| | | Prior to foaming | After foaming |
|---|---|---|---|
| Example | Density | [ppm] | [ppm] |
| 5 | | 48 | 46 |
| 6 | | 103 | 105 |
| 7 | | 205 | 201 |
| 8 | | 526 | 523 |
| 17 | | 53 | 53 |
| 18 | | 102 | 98 |
| 19 | | 203 | 198 |
| 20 | | 511 | 510 |
| 29 | | 48 | 47 |
| 30 | | 98 | 100 |
| 31 | | 202 | 199 |
| 32 | | 486 | 482 |
| 41 | | 51 | 50 |
| 42 | | 102 | 100 |
| 43 | | 218 | 212 |
| 44 | | 497 | 494 |

The bioassay method was similar to the soil termiticide bioassay method described in Su et al. (1993). Out of foamblocks according to the invention cylinders (ca. 2.5-cm diameter by 5.0-cm length) were cut using a 2.5-cm diameter plug cutter and drill press. Each polystyrene cylinder was wedged into a 2.5-cm diameter Tenite® butyrate tube. This tube was then connected by a Tygon tubing collar to another tube containing 80 workers and one soldier. The 5.0-cm polystyrene cylinder was sandwiched between two 3-cm agar segments. Pieces of southern yellow pine and paper strips provided food and harborage for termites in both the tube with termites and the tube with the polystyrene cylinder so that the termites had a source of food both above and below the polystyrene cylinder. The tubes were held at 25° C. during the 7 d of the bioassay.

The distance tunneled through the outside surface of cylinders along the interior wall of the tube was recorded every 24 h. Short (<10 mm) straight tunnels on the exterior of cylinders were measured with a ruler. Longer, curved tunnels were measured by placing a section of a thin rubber band along the length of the tunnel and then measuring the length of the rubber band. The bioassay was terminated after 7 d. At termination, mortality as well as distance tunneled through the interior of cylinders was determined. Tunnels on the interior of cylinders were measured by threading a small piece of 24 gauge insulated telephone wire through a tunnel, withdrawing the wire, and measuring its length with a ruler. To estimate the amount of tunneling through the interior of cylinders that occurred each day, the total distance tunneled through cylinder exteriors during the 7-d bioassay was proportion by day, then the amount of interior tunneling was adjusted according to the proportion of total tunneling that occurred each day.

The results are illustrated in Table 4 and 5.

TABLE 4

| | Mean | Mean external | Mean internal | Mean total |
|---|---|---|---|---|
| | mortality | tunneling | tunneling | tunneling |
| Example | [%] | [cm] | [cm] | [cm] |
| 5 | 89.5 | 3.7 | 7.2 | 10.9 |
| 6 | 81.5 | 4.2 | 7.9 | 12.0 |
| 7 | 98.5 | 2.8 | 3.8 | 6.6 |
| 8 | 99.7 | 3.6 | 4.8 | 8.4 |
| 9 | 99.7 | 5.7 | 4.4 | 10.1 |
| 10 | 98.5 | 5.8 | 2.5 | 8.3 |
| 11 | 99.7 | 2.7 | 1.6 | 4.3 |
| 12 | 99.7 | 1.3 | 1.3 | 2.6 |
| 37 | 86.4 | 4.1 | 2.5 | 6.6 |
| 38 | 99.6 | 3.2 | 3.7 | 6.4 |
| 39 | 97.5 | 4.6 | 2.0 | 6.7 |
| 40 | 96.0 | 1.9 | 2.8 | 4.7 |
| 41 | 56.8 | 5.7 | 5.4 | 11.1 |
| 42 | 93.8 | 3.7 | 3.7 | 7.5 |
| 43 | 96.0 | 4.4 | 4.1 | 8.5 |
| 44 | 97.8 | 2.3 | 2.5 | 4.9 |
| Reference | 23.1 | 6.5 | 6.8 | 13.3 |

TABLE 5

| Example | Mean mortality [%] | Mean total tunneling [cm] |
|---|---|---|
| 73 | 89.8 | 1.2 |
| 74 | 99.7 | 2.3 |
| 75 | 99.4 | 0.7 |
| 76 | 66.7 | 0.3 |
| 77 | 98.5 | 2.0 |
| 78 | 90.1 | 0.0 |
| 79 | 92.9 | 0.8 |
| 80 | 76.9 | 0.0 |
| 81 | 99.1 | 0.8 |
| 82 | 87.7 | 0.8 |
| 83 | 29.9 | 6.2 |
| 84 | 16.0 | 1.8 |
| 85 | 10.5 | 3.4 |

1.-13. (canceled)

14. A bead material composed of expandable polystyrene (EPS), coated with
(A) one or more insecticides,
(B) one or more glycerol esters
(C) optionally one or more binders, and
(D) optionally further additives.

15. The EPS bead material according to claim 14, wherein the insecticide is selected from the group consisting of
I.1 Chlorpyrifos, fenitrothion, isofenphos;
I.2 Carbaryl;
I.3 Bifenthrin, cyfluthrin, cyhalothrin, cypermethrin, alpha-cypermethrin, deltamethrin, fenvalerate, lambda-cyhalothrin, permethrin;
I.4 Diflubenzuron, flufenoxuron, hexaflumuron, noviflumuron, sulfluramid;
I.5 Acetamiprid, imidacloprid, thiacloprid, thiamethoxam;
I.6 Acetoprole, ethiprole (III), fipronil (II), vaniliprole;
I.7 Spinosad;
I.8. Fenazaquin, pyridaben, tebufenpyrad, tolfenpyrad;
I.9. Hydramethylnon (V);
I.10. Chlorfenapyr (VI);
I.11. Cyhexatin, diafenthiuron, fenbutatin oxide, propargite;
I.12. Cyromazine;
I.13. Piperonyl butoxide;
I.14. Indoxacarb, metaflumizone; and
I.15. Borates, chlorantraniliprol, flonicamid.

16. The EPS bead material according to claim 15, wherein the insecticide(s) is selected from the group consisting of fipronil, hydramethylnon and chlorfenapyr.

17. The EPS bead material according to claim 14, wherein the binder is required and is a polymer dispersion(s) whose MFT is from −5 to +35° C.

18. The EPS bead material according to claim 14, wherein the binder is required and is an acrylate dispersion(s).

19. The EPS bead material according to claim 14, wherein the glycerol ester is one or more compounds of the formula (X) 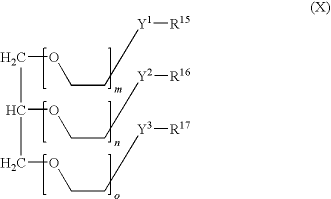
in which the definitions of the symbols and indices are as follows:
m, n, and o, independently of one another, are whole numbers from 0 to 10;
Y¹, Y², and Y³, independently of one another, are —O—, —S—, or —NR¹⁸—;
R¹⁸ is hydrogen or C₁-C₁₀-alkyl;
R¹⁵, R¹⁶, and R¹⁷, independently of one another, are hydrogen, —SO R¹⁹, —SO₂ R¹⁹, —SO₃ R¹⁹ or —COR¹⁹;
R¹⁹ is hyrogen, C₁-C₃₀-alkyl, where the alkyl radical is straight-chain or branched, saturated, or comprises one or more C—C double or C—C triple bonds and is unsubstituted or substituted with one or more radicals from the group of hydroxy, oxo, and COOR²⁰ and where R²⁰ is C₁-C₆-alkyl.

20. A molding obtainable from EPS bead material according to claim 14.

21. The molding according to claim 20, wherein one or more binders is present at total concentrations of from 0.005 to 4.0% by weight, based on the weight of the molding, and wherein an insecticide is present at total concentrations of from 10 to 1000 ppm, based on the weight of the molding.

22. A process for the production of a molding which comprises press molding, where
I) an EPS bead material according to claim 14 is charged to a gas-permeable mold,
II) within the closed mold, the charge of bead material is press-molded to give a molding, with volume reduction,
III) the molding is hardened by controlling its temperature to from 20 to 100° C., and
IV) the resultant molding is removed from the mold.

23. A process for the production of a molding which comprises foaming-to-completion, where
i) an EPS bead material according to claim 14 is charged to a gastight mold,
ii) within the closed mold, the charge of bead material is foamed to completion by controlling its temperature to from 60 to 120° C., whereupon the bead material fuses to give the molding, and
iii) the resultant molding is removed from the mold.

24. A process for the protection of a building from termites, wherein moldings according to claim 20 are incorporated into the base, the outwalls or the roof of the building to be protected.
